(19) United States
(12) Patent Application Publication
(10) Pub. No.: US 2007/0012765 A1
(43) Pub. Date: Jan. 18, 2007

(54) Device for representing a multiple-use comsumption ticket by means of a bar code

(76) Inventors: Dominique Trinquet, Caen (FR); Xavier Piednoir, Caen (FR)

Correspondence Address: COHEN, PONTANI, LIEBERMAN & PAVANE, 551 FIFTH AVENUE, SUITE 1210, NEW YORK, NY, 10176, US

(21) Appl. No.: 10/551,002

(22) PCT Filed: Mar. 9, 2004
(86) PCT No.: PCT/FR04/00564

§ 371 Date: Jul. 24, 2006

(30) Foreign Application Priority Data
Mar. 27, 2003 (FR) 03/03798

(51) Int. Cl. G06K 5/00; G06K 7/01; G06K 7/10

(52) U.S. Cl. 235/382; 235/382.5; 235/462.13; 235/462.01

(57) ABSTRACT

A device for displaying a bar code to represent a multiple-use consumption ticket in respect of a product or service, the device comprising a terminal (10) comprising communications means (11) adapted to receive a message containing order data in respect of said product or service, and graphical output means (12) adapted to represent said multiple-use consumption ticket in the form of a bar code. The terminal (10) further comprises means (21, 22) for storing said order data, an indicator of use of the multiple-use consumption ticket, and data relating to the terminal (10) and to the user, a module (33) for transferring order data received by said communications means (11) to said storage means (21, 22) a bar code generation module (41) adapted to generate a bar code representing the product or service ordered based on the order data, the use indicator, and the data relating to the user, and an image conversion module (42) adapted to supply said consumption ticket to the graphical output means (12) of the terminal (10) by converting the bar code generated by the bar code generation module (41) as a function of the data relating to the terminal (10).

The present invention relates to a device for representing by means of a bar code a multiple-use ticket for the consumption of a product or a service.

The invention finds an application in the general field of remote e-commerce, and more particularly, although not exclusively, in the field of e-commerce in which a mobile user can order a given product or service and obtain on a terminal a bar code representing a ticket enabling the product or service ordered in this way to be “consumed”.

The expression “consumption ticket” means not only any form of ticket as such, for example entertainment or travel tickets, but also any other form of non-material rights (discount coupon, loyalty token, etc.) or even just a means of authenticating a person, for example for the purposes of debiting a prepaid account.

Nevertheless, the invention applies more particularly to the situation of consumption tickets that are for “multiple use” in the sense that a user can “consume” a product or service associated with a single consumption ticket on more than one occasion, in compliance with the kind of ticket issued. Examples of kinds of ticket that can be mentioned include season tickets, which are issued for a given number of uses (for example a travel ticket issued for a given number of journeys), and fixed price tickets, which are issued for a given period of use (for example a ski pass for using a ski lift that is valid for the duration of a stay in a ski resort).

As explained in more detail below, the invention can utilize all kinds of terminals, such as mobile telephones, personal digital assistants (PDA) with a communications capability, and personal computers (PC), what is essential being that they are provided with:

communications means adapted to receive a message containing data for ordering said product or service, and

graphical output means adapted to represent said multiple-use consumption ticket in the form of a bar code. Depending on the terminal envisaged, said graphical output means will be a graphical display screen or a printer.

There follows an outline of the principle of the consumption of a product or service by means of a ticket represented in the form of a bar code on a terminal. Using a terminal, a user orders remotely a product or service from a trader or via a telecommunications operator, for example an entertainment ticket or a travel ticket. Following confirmation of the order and the payment, the user receives an electronic consumption ticket that can be displayed on graphical output means of the terminal in the form of a bar code. When the product or service covered by the electronic ticket is consumed, it suffices for the user to present the bar code displayed on said graphical output means to an appropriate reader, which is placed at the entrance to an auditorium, for example. If the ticket presented in this way is recognized as valid by the reader, then the user is allowed to use it, in other words in the present example to enter the auditorium.

This principle of electronic ticketing addresses a large market: travel, entertainment, large retailers. This solution has the advantage of being simple to set up and of necessitating little investment, at most the purchase of a bar code scanner and the associated software.

There are various types of ticketing platform that use a bar code to represent a consumption ticket on a terminal. In particular, French Patent Application 02 11233 describes a platform of this kind.

However, although they cover well the requirements of ticketing solutions for single-use consumption tickets, prior art platforms are not well adapted to the representation by means of bar codes of multiple-use tickets such as season tickets or fixed charge tickets.

Accordingly, the technical problem to be solved by the present invention is that of proposing a device for displaying a bar code to represent a multiple-use ticket for the consumption of a product or service, the device comprising a terminal comprising:

communications means adapted to receive a message containing order data in respect of said product or service, and

graphical output means adapted to represent said multiple-use consumption ticket in the form of a bar code,

which device should facilitate the representation of multiple-use consumption tickets on the principle of displaying a bar code on a terminal.

According to the present invention, the solution to the stated technical problem consists in that said terminal further comprises:

means for storing said order data, an indicator of use of the multiple-use consumption ticket, and data relating to the terminal and to the user,

a module for transferring to said storage means order data received by said communications means,

a bar code generation module adapted to generate a bar code representing the product or service ordered based on the order data, the use indicator, and the data relating to the user, and

an image conversion module adapted to supply said consumption ticket to the graphical output means of the terminal by converting the bar code constituted by the generation module as a function of the data relating to the terminal.

Accordingly, the representation device of the invention is able to take account of the multiple-use nature of the consumption ticket by processing received order data in the terminal itself, in particular by generating a use indicator that is stored in the terminal and that is included in the bar code on each consumption until the ticket is used up.

Moreover, after the multiple-use ticket of the invention has been stored in the terminal, it is the terminal alone that autonomously monitors all subsequent uses of the ticket, which has the essential advantage that the ticket can be used in any circumstances, in particular outside a geographical coverage area if the terminal is a mobile telephone. For example, the benefit of this is clear in the situation of fixed charges for using ski-lifts in winter sports resorts, which are usually situated in mountainous areas that are not covered by mobile telephone networks.

To be more precise, if the multiple-use ticket is a season ticket for a given number of uses, said use indicator constitutes means for counting the number of uses. These counting means may be means for incrementing or decrementing a counter indicating the number of uses already effected or the number of uses remaining.

Similarly, in another embodiment, if the multiple-use ticket is a fixed charge ticket for a given period of use, said use indicator is an expiry date of said fixed charge. The consumption ticket can then be used until the expiry date is reached.

Again in the situation of a fixed charge, the bar code generated by said generation module may comprise information relating to the date of generation of said bar code. This advantageous feature makes it possible to check that the ticket is still valid by reading the bar code when the ticket is presented.

For security purposes, said bar code may also include information relating to a validity period that starts from the date of generation of the bar code and that is typically set by the user. In this case, a fraudster who has succeeded in misappropriating the bar code of the ticket will have only a limited time in which to use it.

In one particular embodiment of the representation device in the invention said terminal includes a watchdog module adapted to detect the reception of a message containing order data and to store said message in an inbox of the terminal, the transfer module being adapted to transfer the order data of the message from the inbox to said storage means.

This feature means that at least the bar code generation module and the image conversion module can constitute a unit that is out of circuit in the terminal in the absence of a user action.

The term “action” means using, transferring, exchanging, or canceling the consumption ticket.

Accordingly, so long as the watchdog module is not activated by an action of the operator, the unit comprising at least the bar code generation module and the image conversion module remains out of circuit, in the sense that it is disconnected from the processor of the terminal, preventing unnecessary power consumption therein.

The following description with reference to the appended drawing, which is provided by way of non-limiting example, explains what the invention consists in and how it can be reduced to practice.

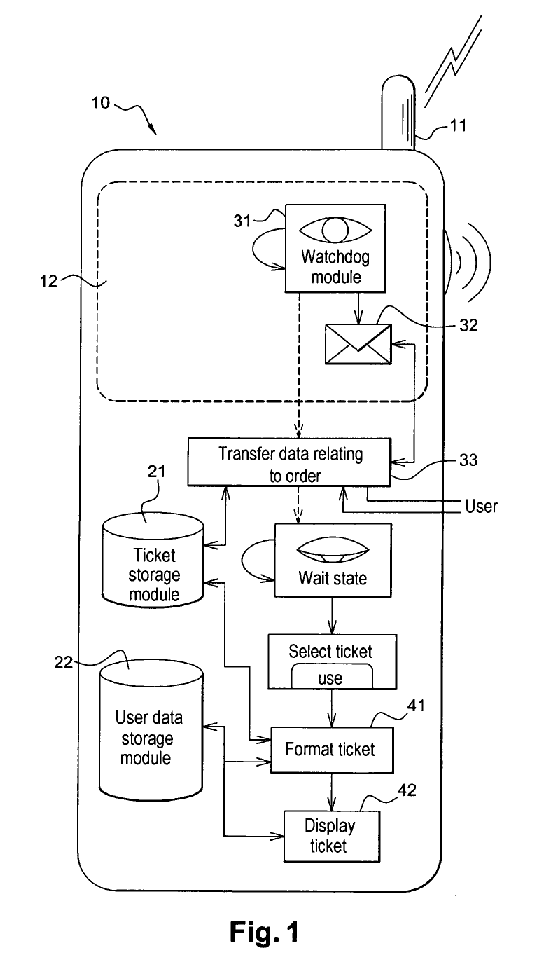

FIG. 1 is a diagram of a terminal integrating a device in accordance with the invention for representing a multiple-use consumption ticket by means of a bar code.

The purpose of the FIG. 1 device is to display a bar code to represent a ticket for the multiple use (“consumption”) of a product or service.

As may be seen in FIG. 1, the device essentially comprises a terminal 10. In the present example the terminal 10 is a mobile telephone, although it is to be understood that it could equally well be any other type of terminal, such as a personal digital assistant (PDA), or even a personal computer (PC).

The terminal 10 shown in FIG. 1 includes communications means, represented diagrammatically by an antenna 11, that are provided for normal use of the terminal, generally for communication via a telephone network, preferably a mobile telephone network. The user receives messages on the terminal 10, via these communications means, which messages come from a trader's server containing data relating to the order for the product or service covered by the multiple-use consumption ticket to be represented in the form of a bar code.

The terminal 10 further comprises graphical output means adapted to represent said multiple-use consumption ticket in the form of a bar code. In the FIG. 1 embodiment, the graphical output means consist of a graphical display screen 12 of the mobile telephone 10. The user presents the ticket displayed on the graphical display screen to the reader to gain access to the multiple-use product or service concerned on each consumption thereof, after verification by the reader of the validity of the ticket.

At the input of the FIG. 1 device there is a watchdog module 31 responsible for intercepting all incoming messages, detecting a message containing order data and storing it, like any other message, in the inbox 32 of the terminal 10 appropriate to the communications channel used. The order messages may be electronic mail, SMS (Short Message Service), MMS (Multimedia Message Service), WAP (Wireless Application Protocol), Bluetooth, IrDA, etc. messages.

When the watchdog module 31 detects an order data reception message, the user receives a notification from a transfer module 33, which waits for an instruction from the user to accept or refuse the message.

After the user accepts the order message, the transfer module 33 transfers data relating to the order extracted from the message received from the trader's server from the inbox 32 of the terminal to the storage means 21. During this operation, the data is converted to a common format, for example the GTD (Generic Ticket Description) format, which constitutes a generic representation of the ticket, independent of the form assumed by the input data: electronic mail, SMS, MMS, etc. This conversion may be effected by software modules adapted to interpret the formats of tickets from different providers. These modules are either local modules in the terminal itself or, to be more certain that the network is not used to convey counterfeit tickets, remote modules on the premises of the operators.

The order data received by the terminal is therefore transferred automatically to the first storage means 21 as soon as the user agrees to receive it. It follows that it is then no longer possible to transfer the data relating to the consumption ticket from the inbox 32 and therefore to duplicate it by sending it to a third party. This makes fraud impossible. Of course, in addition to consuming the ticket the user can, if so required, effect some other action, such as transferring the ticket to a third party or even exchanging it or canceling it. Nevertheless, these operations can be effected only from the first storage means 21 and the corresponding data is destroyed as soon as it has been transferred, exchanged, or cancelled.

The data stored in the first storage means 21 describes the multiple-use product or service that has been ordered, for example a season ticket to a public transport network (line, route, etc.) or a fixed charge pass for using the ski-lift in a winter sports resort. Moreover, this data relating to the product or service is accompanied by an indicator of use of the multiple-use ticket, such as the number of times it has been used already or the remaining number of uses in the case of a season ticket, or an expiry date in the case of a fixed charge ticket.

A product or service consumed on payment of a fixed charge is more vulnerable to fraud than a season ticket, and to make this kind of product or service more secure it is advantageous for a ticket generation date to be included in the bar code generated each time the ticket is used. It is then possible to verify that the ticket presented to the reader is valid. Moreover, the user can even fix a validity period running from said bar code generation date, which limits the time for which a fraudster could use a bar code after successfully misappropriating it.

Similarly, second storage means 22 enable the retention in memory of other information useful for generating the multiple-use consumption ticket, namely personal information relating to the user, such as the user's ID or address, or data relating to the terminal 10, such as the width of the graphical display screen 12 or the facility for display in color.

When the user decides to use the ticket, a unit consisting of a bar code generation module 41 and an image conversion module 42 displays a bar code on the graphical display screen 12, which bar code complies with the requirements for a multiple-use ticket for the product or service concerned.

The function of the bar code generation module 41 is to generate a bar code representing the product or service that has been ordered, based on the order data, the use indicator, and the data relating to the user, and allowing for various existing systems of symbols. To this end, the bar code generation module 41 is adapted to collect and aggregate the order data and the use indicator stored in the first storage means 21 and the data relating to the user stored in the second storage means 22.

The module 41 includes modules for formatting bar codes in accordance with particular systems of symbols and which may therefore include modules for formatting Aztec, Datamatrix, QR code, EAN 13 and PDF 417 codes. This modular entity is therefore able to evolve as a function of new systems of symbols that prove to be compatible with electronic ticketing applications, for example as a function of the evolution of terminals. For example, the bar code is simply generated in the neutral General Picture Format (GPF), which is independent of the output format, and sent to the image conversion module 42.

When the bar code has been generated, the module 41 updates the first storage means 21 by modifying the indicator of use of the multiple-use ticket to update it for a subsequent use. Of course, if this is the last use, the ticket data in the first storage means 21 is deleted. Where applicable, the bar code generation module 41 provides the second storage means 22 with consumption information, such as loyalty points or data for producing statistics on the use of the product or service.

The purpose of the image conversion module 42 is to handle entry of the neutral GPF bar code and its conversion to the required output format. In other words, the module 42 supplies the consumption ticket in the form of a bar code that can be represented on the graphical output means 12 on the terminal 10. To convert the bar code, the module 42 uses the data relating to the terminal stored in the second storage means 22.

The watchdog module 31 and the transfer module 33 form a unit that is constantly waiting for an order data message or a user action and is therefore connected at all times to the processor of the terminal 10.

However, even if the terminal 10 is operating, the bar code generation module 41 and the image conversion module 42 constitute a unit that is out of circuit in the terminal in the absence of user action. This avoids unnecessary consumption of power by the processor of the terminal 10.

1. A device for displaying a bar code to represent a multiple-use consumption ticket in respect of a product or service, the device comprising a terminal (10) comprising:
communications means (11) adapted to receive a message containing order data in respect of said product or service;
graphical output means (12) adapted to represent said multiple-use consumption ticket in the form of a bar code;
means (21, 22) for storing said order data, an indicator of use of the multiple-use consumption ticket, and data relating to the terminal (10) and to the user;
a module (33) for transferring order data received by said communications means (11) to said storage means (21, 22);
a bar code generation module (41) adapted to generate a bar code representing the product or service ordered based on the order data, the use indicator, and the data relating to the user; and
an image conversion module (42) adapted to supply said consumption ticket to the graphical output means (12) of the terminal (10) by converting the bar code generated by the bar code generation module (41) as a function of the data relating to the terminal (10).

2. A device according to claim 1, wherein the multiple-use ticket is a season ticket for a given number of uses, said use indicator constitutes means for counting the number of uses.

3. A device according to claim 1, wherein the multiple-use ticket is a fixed charge ticket for a given period of use, said use indicator is an expiry date of said fixed charge.

4. A device according to claim 3, wherein the bar code generated by said bar code generation module (41) includes information relating to the date of generation of said bar code.

5. A device according to claim 4, wherein said bar code also includes information relating to a validity period.

6. A device according to claim 1, wherein said transfer module (33) is adapted to notify the user of a consumption ticket order data reception message and to receive an instruction for action from the user.

7. A device according to claim 6, wherein said action is the consumption, transfer, exchange, or cancellation of the consumption ticket.

8. A device according to claim 1, wherein said terminal (10) includes a watchdog module (31) adapted to detect the reception of a message containing order data and to store said message in an inbox (32) of the terminal, the transfer module 31) being adapted to transfer the order data of the message from the inbox (32) to said storage means (21,22).

9. A device according to claim 1, wherein at least the bar code generation module (41) and the image conversion module (42) constitute a unit that is out of circuit in the terminal (10) in the absence of a user action.

10. A device according to claim 1, wherein said terminal is a mobile telephone (10) and the graphical output means are a graphical display screen (12).
